(19) United States
(12) Patent Application Publication
(10) Pub. No.: US 2025/0023153 A1
(43) Pub. Date: Jan. 16, 2025

(54) SECONDARY BATTERY

(71) Applicant: SAMSUNG SDI CO., LTD., Yongin-si (KR)

(72) Inventors: Young Chang LIM, Yongin-si (KR); Yeon Bok JEONG, Yongin-si (KR); Kyeong Yun PARK, Yongin-si (KR); Eun Song LEE, Yongin-si (KR); Min Seung KANG, Yongin-si (KR); Myeong Jun JO, Yongin-si (KR)

(21) Appl. No.: 18/436,800

(22) Filed: Feb. 8, 2024

(30) Foreign Application Priority Data
Jul. 13, 2023 (KR) 10-2023-0090965

(51) Int. Cl. H01M 50/124; H01M 10/04; H01M 50/105; H01M 50/121

(52) U.S. Cl. CPC H01M 50/1243; H01M 10/04; H01M 50/105; H01M 50/121

(57) ABSTRACT

Embodiments of the present disclosure relate to a secondary battery having a structure capable of reducing shape deformation of a pouch. A secondary battery includes: an electrode assembly; a pouch case accommodating the electrode assembly together with an electrolyte; and a deformation preventing portion at an inner side facing a terminal formation portion of the pouch case.

### CROSS-REFERENCE TO RELATED APPLICATION

This application claims priority to and the benefit of Korean Patent Application No. 10-2023-0090965, filed on Jul. 13, 2023 in the Korean Intellectual Property Office, the entire disclosure of which is incorporated herein by reference.

### BACKGROUND

### 1. Field

Aspects of embodiments of the present disclosure relate to a secondary battery.

### 2. Description of the Related Art

A secondary battery is configured such that an electrode assembly is formed by winding or stacking a positive electrode, a negative electrode, and a separator interposed between the positive electrode and the negative electrode, and the electrode assembly is sealed together with an electrolyte in a can or pouch.

A manufacturing process of a pouch-type secondary battery includes steps of forming a pouch, inserting an electrode assembly with an electrolyte, and sealing the pouch. Generally, in order to improve an electrode assembly insertion performance in the pouch forming step, the pouch is formed to be larger than the electrode assembly. As a result, an empty space is formed inside the pouch. However, by repeating charging and discharging processes, excess electrolyte filling the empty space is impregnated and a negative pressure is formed inside the pouch, which may cause deformation to a shape of a lower portion of the pouch. When the shape of the pouch is deformed, a pack tape may sometimes be attached. However, in this case, problems with the attached pack tape lifting or issues with exterior quality may occur.

The above information disclosed in this Background section is provided for enhancement of understanding of the background of the invention and, therefore, it may contain information that does not constitute prior art.

### SUMMARY

According to an aspect of embodiments of the present disclosure, a secondary battery having a structure capable of preventing (preventing or reducing) shape deformation of a pouch is provided.

According to one or more embodiments, a secondary battery includes: an electrode assembly; a pouch case accommodating the electrode assembly together with an electrolyte; and a deformation preventing portion at an inner side facing a terminal formation portion of the pouch case.

The deformation preventing portion may be formed by any of attachment of a curable tape, application and curing of a coating agent, and spraying and curing of a coating agent.

The coating agent may include a resin containing one or more of acrylic, epoxy, polyurethane, polyimide, unsaturated ester, phenol, urea, and melamine resins.

The deformation preventing portion may have a shape of at least one straight bar.

The deformation preventing portion may be arranged as a plurality of deformation preventing portions.

The deformation preventing portion may have any of semicircular, circular, and polygonal shapes.

The plurality of deformation preventing portions may be arranged at equal intervals.

The plurality of deformation preventing portions may be arranged at different intervals.

The plurality of deformation preventing portions may be arranged such that an arrangement density thereof at edge and center regions of the inner side of the pouch case is greater than that at remaining regions of the pouch case.

The deformation preventing portion may be formed by forming a curing material into a plurality of spots.

The plurality of spots of the curing material may be arranged at equal intervals.

The plurality of spots of the curing material may be arranged to form a plurality of groups.

The plurality of spots of the curing material may be arranged such that an arrangement density thereof at edge and center regions of the inner side of the pouch case is greater than that at remaining regions of the pouch case.

### BRIEF DESCRIPTION OF DRAWINGS

FIG. 1 is a perspective view showing a secondary battery according to an embodiment of the present disclosure.

FIGS. 2A to 2D show a process of manufacturing a secondary battery according to an embodiment of the present disclosure.

FIG. 3 shows a shape of a deformation preventing portion of a secondary battery according to an embodiment of the present disclosure.

FIG. 4 shows a shape of a deformation preventing portion of a secondary battery according to another embodiment of the present disclosure.

FIG. 5 shows a shape of a deformation preventing portion of a secondary battery according to another embodiment of the present disclosure.

FIG. 6 shows a shape of a deformation preventing portion of a secondary battery according to another embodiment of the present disclosure.

FIG. 7 shows a shape of a deformation preventing portion of a secondary battery according to another embodiment of the present disclosure.

FIG. 8 shows a shape of a deformation preventing portion of a secondary battery according to another embodiment of the present disclosure.

FIG. 9 shows a shape of a deformation preventing portion of a secondary battery according to another embodiment of the present disclosure.

FIG. 10 shows a shape of a deformation preventing portion of a secondary battery according to another embodiment of the present disclosure.

### DETAILED DESCRIPTION

Some example embodiments of the present disclosure are provided to more completely explain the present disclosure to those skilled in the art, and the following examples may be modified in various other forms. The present disclosure, however, may be embodied in many different forms and should not be construed as being limited to the example embodiments set forth herein. Rather, these example embodiments are provided so that this disclosure will be thorough and complete and will convey the aspects and features of the present disclosure to those skilled in the art.

In addition, in the accompanying drawings, sizes or thicknesses of various components may be exaggerated for brevity and clarity. Like numbers refer to like elements throughout. As used herein, the term “and/or” includes any and all combinations of one or more of the associated listed items. In addition, it is to be understood that when an element A is referred to as being “connected to” an element B, the element A may be directly connected to the element B or one or more intervening elements C may be present therebetween such that the element A and the element B are indirectly connected to each other.

The terminology used herein is for the purpose of describing particular embodiments and is not intended to be limiting of the disclosure. As used herein, the singular forms are intended to include the plural forms as well, unless the context clearly indicates otherwise. It is to be further understood that the terms “comprise” or “include” and/or “comprising” or “including,” when used in this specification, specify the presence of stated features, numbers, steps, operations, elements, and/or components, but do not preclude the presence or addition of one or more other features, numbers, steps, operations, elements, components, and/or groups thereof.

It is to be understood that, although the terms “first,” “second,” etc. may be used herein to describe various members, elements, regions, layers, and/or sections, these members, elements, regions, layers, and/or sections are not to be limited by these terms. These terms are used to distinguish one member, element, region, layer, and/or section from another. Thus, for example, a first member, a first element, a first region, a first layer, and/or a first section discussed below could be termed a second member, a second element, a second region, a second layer, and/or a second section without departing from the teachings of the present disclosure.

Spatially relative terms, such as “beneath,” “below,” “lower,” “above,” “upper,” and the like, may be used herein for ease of description to describe one element or feature's relationship to another element(s) or feature(s), referring to the figures. It is to be understood that the spatially relative terms are intended to encompass different orientations of the device in use or operation in addition to the orientation depicted in the figures. For example, if the element or feature in the figures is turned, elements described as “below” or “beneath” other elements or features would then be oriented “on” or “above” the other elements or features, for example. Thus, the example term “below” can encompass both an orientation of above and below.

Unless otherwise defined, all terms (including technical and scientific terms) used herein have the same meaning as commonly understood by one of ordinary skill in the art to which the inventive concept pertains. It is also to be understood that terms defined in commonly used dictionaries should be interpreted as having meanings consistent with the meanings in the context of the related art, and are expressly defined herein unless they are interpreted in an ideal or overly formal sense.

Herein, a secondary battery according to an embodiment of the present disclosure will be described in further detail with reference to the attached drawings.

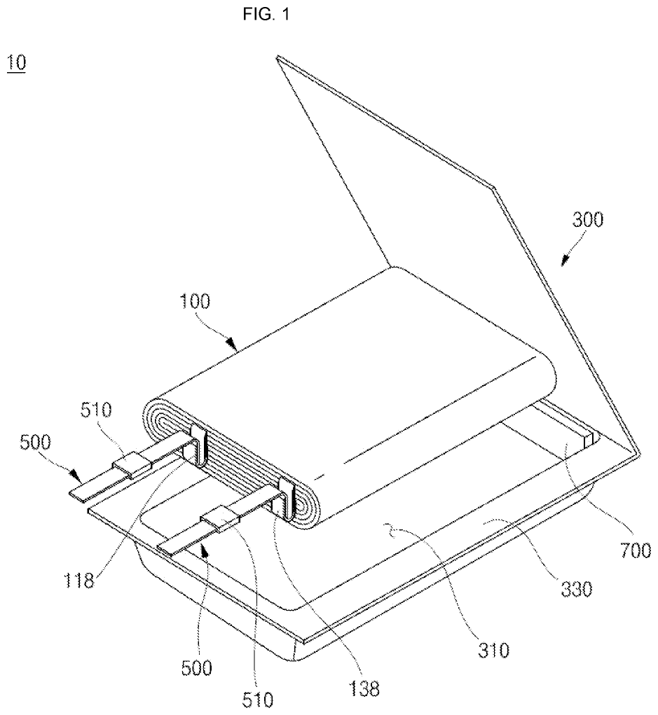

FIG. 1 is a perspective view showing a secondary battery according to an embodiment of the present disclosure. As shown in FIG. 1, a secondary battery 10 according to an embodiment of the present disclosure may include an electrode assembly 100 and a pouch case 300 for accommodating the electrode assembly 100. In addition, the secondary battery 10 may further include a strip terminal 500 that electrically connects the electrode assembly 300 to the outside and a deformation preventing portion 700 for preventing deformation of the pouch case 300.

The electrode assembly 100 may be formed by winding or stacking a thin or film-shaped laminate of a negative electrode plate (not shown), a separator (not shown), and a positive electrode plate (not shown). The negative electrode plate and the positive electrode plate may be electrically connected to the outside of the secondary battery 10 by the strip terminal 500 that serves as an electrode lead. The electrode assembly 100 may also be referred to as a jelly roll. In the present disclosure, the electrode assembly 100 is explained as an example in a wound form, but is not limited thereto. An electrode assembly stacked in a stack form may also be applied.

For example, the negative electrode plate may be formed by applying a negative electrode active material, such as graphite or carbon, to a negative electrode current collector made of a metal foil, such as copper, a copper alloy, nickel, or a nickel alloy. Here, an electrode uncoated portion to which the negative electrode active material is not applied may be formed in some regions of the negative electrode current collector, and a plurality of negative electrode substrate tabs 118 may be formed on the electrode uncoated portion. In an embodiment, the negative electrode substrate tab 118 may be connected to the strip terminal 500 by welding. Accordingly, the negative electrode substrate tab 118 becomes a path for current flow between the negative electrode plate and the strip terminal 500.

The separator is interposed between the negative electrode plate and the positive electrode plate to prevent or substantially prevent a short circuit between the negative electrode plate and the positive electrode plate and enable the movement of lithium ions.

The positive electrode plate may be formed by applying a positive electrode active material, such as a transition metal oxide, to a positive electrode current collector made of a metal foil, such as aluminum or an aluminum alloy. An electrode uncoated portion on which the positive electrode active material is not applied may be formed in some regions of the positive electrode current collector, and a plurality of positive electrode substrate tabs 138 may be formed on the electrode uncoated portion. In an embodiment, the positive electrode substrate tab 138 may be connected to the strip terminal 500 by welding. Accordingly, the positive electrode substrate tab 138 becomes a path for current flow between the positive electrode plate and the strip terminal 500.

The negative electrode substrate tab 118 and the positive electrode substrate tab 138 are each electrically connected to the strip terminal 500, which serves as an electrode lead. An end of the strip terminal 500 is connected to the negative electrode and positive electrode base tabs 118 and 138 of the electrode assembly 100, and another end of the strip terminal 500 may be exposed to the outside of the pouch case 300. The strip terminal 500 electrically connects the outside of the secondary battery 10 and the negative and positive electrode substrate tabs 118 and 138. The strip terminal 500 may be in the form of a thin film or a film, and may include an insulating portion 510 for being insulated from the pouch case 300. The insulating portion 510 may be formed in a region in contact with the pouch case 300.

The electrode assembly 100 having such a structure is accommodated in the pouch case 300 together with an electrolyte.

As shown in FIG. 1, the pouch case 300 may have a receiving space capable of accommodating the electrode assembly 110. The pouch case 300 may be referred to as a laminated exterior material, a case, a pouch exterior material, a pouch case, etc. The pouch case 300 may be made to have a recess 310 by bending plate-shaped exterior materials to face each other and then pressing or drawing a side. The electrode assembly 100 is accommodated in the recess 310. Sealing portions 330 are formed on the outer periphery of the recess 310. In a state in which the electrode assembly 100 is accommodated in the recess 310, the sealing portions 330 are sealed by heat fusion or the like. An end of the strip terminal 500 may be exposed to the outside of the pouch case 300 in a state in which the above-described insulating portion 510 is located between the sealing portions 330.

The deformation preventing portion 700 is provided on an inner side of the pouch case 300 facing the terminal formation portion, that is, the portion where the strip terminal 500 is placed. Accordingly, the deformation preventing portion 700 faces an end opposite to an end of the electrode assembly 100 where the negative electrode substrate tab 118 and the positive electrode substrate tab 138 are formed. For example, for the process of inserting the electrode assembly 100 into the pouch case 300, the pouch case 300 is formed to be larger than the electrode assembly 100, thereby forming an empty space between the inner side of the pouch case 300 and the electrode assembly 100. In this case, the deformation preventing portion 700 prevents (prevents, substantially prevents, or reduces) deformation of the pouch case 300 due to pressure reduction caused by impregnation of the empty space with the electrolyte. Therefore, the shape of the pouch case 300 can be maintained in its original form.

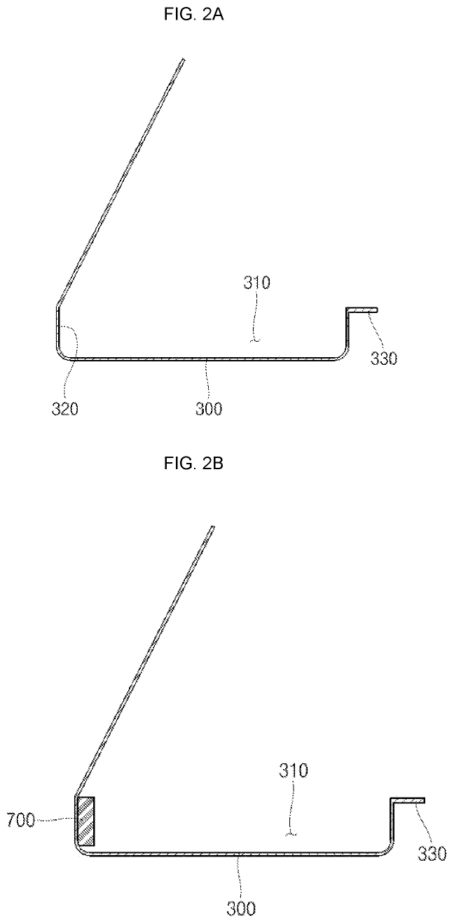

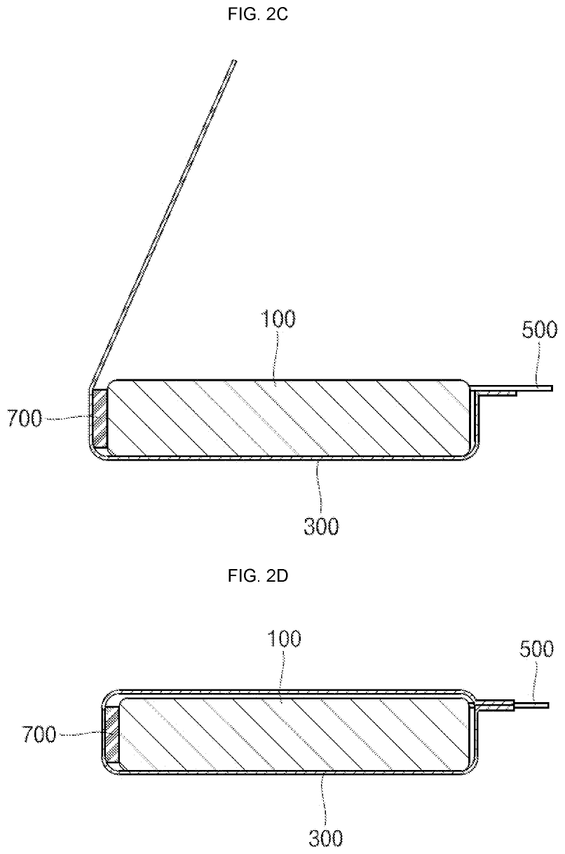

Herein, a method of forming the above-described deformation preventing portion on an inner side of the pouch case and inserting the electrode assembly into the pouch case will be described. FIGS. 2A to 2D briefly show a method of forming a deformation preventing portion according to FIG. 1 and sealing a pouch case after inserting an electrode assembly. For convenience of illustration and purposes of understanding, the pouch case and the electrode assembly are schematically shown in the cross-sectional shapes in FIGS. 2A to 2D.

FIG. 2A shows the pouch case 300 in which the recess 310 is formed after bending the plate-shaped exterior material as described above. In FIG. 2A, the right portion of the pouch case 300 corresponds to the terminal formation portion where the strip terminal 500 is placed.

Referring to FIG. 2B, the deformation preventing portion 700 is formed on an inner side 320 facing the terminal formation portion of the pouch case 300. In an embodiment, a curable tape may be applied as the deformation preventing portion 700. The curable tape may include any of OPP, silicone, PET, non-woven fabric, PI, and an OPS material. The curable tape may include an adhesive layer formed on a side so as to be attached to the inner side of the pouch case 300.

As shown in FIG. 2C, after forming the deformation preventing portion 700 on the inner side of the pouch case 300, the electrode assembly 100 is inserted into the pouch case 300. Then, as shown in FIG. 2D, the sealing portions 330 of the pouch case 300 are sealed to each other by heat fusion, etc.

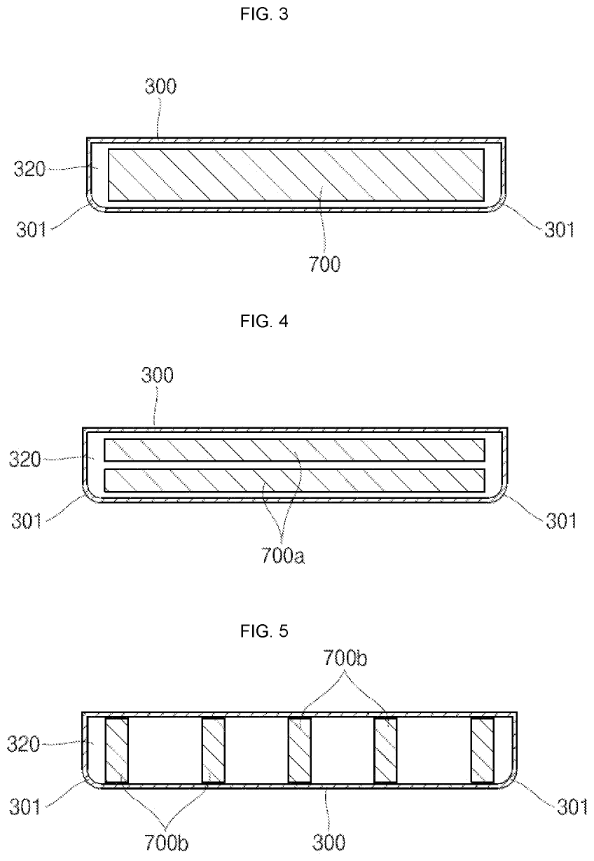

FIGS. 3 to 6 show examples of deformation preventing portions 700 to 700c formed by tape attachment. First, referring to FIG. 3, the deformation preventing portion 700 may have a shape of a single straight bar.

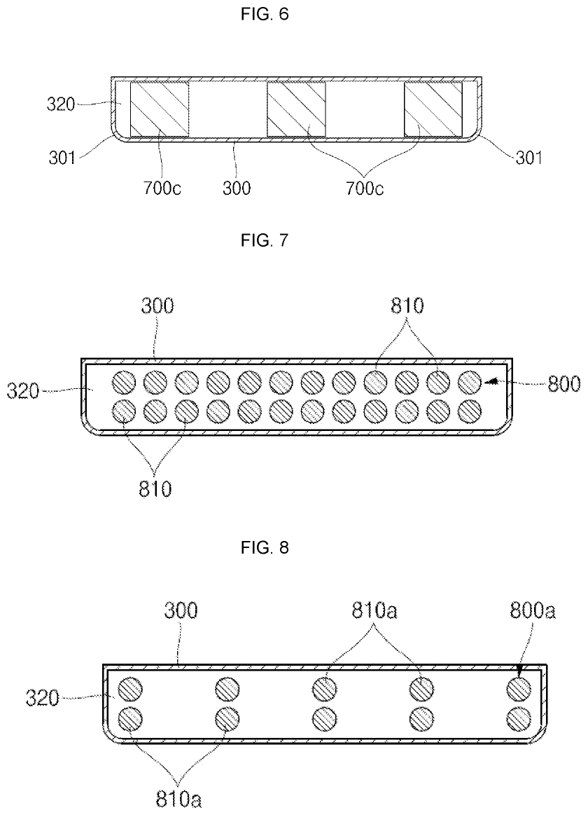

As shown in FIGS. 4 to 6, in some embodiments, a plurality of deformation preventing portions 700a to 700c of a certain shape (e.g., a preset shape) may be arranged. For example, as shown in FIG. 4, a plurality of straight bar-shaped deformation preventing portions 700a may be arranged along the longitudinal direction of the inner side of the pouch case 300. Here, the plurality of deformation preventing portions 700a may be arranged to be spaced apart in the thickness direction of FIG. 4 (in the vertical direction in FIG. 4). In an embodiment, as shown in FIG. 5, a plurality of short bar-shaped deformation preventing portions 700b may be arranged to be spaced apart in the width direction of FIG. 5 (in the horizontal direction in FIG. 5). In an embodiment, as shown in FIG. 6, a plurality of square-shaped deformation preventing portions 700c may be arranged to be spaced apart in the width direction of FIG. 6 (in the horizontal direction in FIG. 6). The plurality of deformation preventing portions 700a to 700c may be arranged at equal or different intervals. The deformation preventing portions 700a to 700c may have any of various shapes including, for example, a semicircular, circular, or polygonal shape.

In addition, when forming the plurality of deformation preventing portions 700, an arrangement density thereof at edge and center regions of the inner side of the pouch case 100 may be greater than that at the remaining regions thereof. This is illustrated in FIG. 6. Accordingly, it is possible to effectively prevent or reduce shape deformation of the edge and center regions, where shape deformation of the relatively large pouch case 300 may occur.

Referring to FIGS. 3 to 6, the deformation preventing portions 700 to 700c may be formed such that a width-direction region thereof is in a range in which a rounded portion 301 formed at a corner of the inner side of the pouch case 300 is avoided. For example, as shown in FIGS. 3 and 4, the deformation preventing portions 700 and 700a may be formed such that long sides thereof, that is, upper and lower sides of the deformation preventing portions 700 and 700a in FIGS. 3 and 4, do not interfere with the rounded portion 301. In addition, as shown in FIGS. 5 and 6, when a plurality of deformation preventing portions 700b and 700c are arranged, the deformation preventing portions 700b and 700c may be formed such that an entire region occupied thereby avoids the rounded portion 301 in the width direction.

In an embodiment, the length of the deformation preventing portion 700 in the thickness direction, that is, in FIG. 3, the vertical length of the deformation preventing portion 700, may be formed to be within 100% of a thickness of the electrode assembly 100.

According to an embodiment of the present disclosure, the deformation preventing portion 700 may be formed by application. In the case of the application method, in an embodiment, when a coating agent is applied through a nozzle, curing is performed by UV curing or heat curing, thereby forming the deformation preventing portion 700. The coating agent may include, for example, any of acrylic, epoxy, polyurethane, polyimide, unsaturated ester, phenol, urea, and melamine resins, and materials containing any of these may also be used. For example, the deformation preventing portion 700 formed by the application method may be formed to have a same shape and arrangement as those of the deformation preventing portion formed by the tape attachment shown in FIGS. 3 to 6. Therefore, the description of the shape, arrangement, size, etc. of the deformation preventing portion 700 formed by the above-described tape attachment can also be applied to the deformation preventing portion 700 formed by the spraying method.

In another embodiment of the present disclosure, the deformation preventing portion 700 may be formed by a spraying method. In the case of the spray method, the deformation preventing portion 700 may be formed by curing a coating agent through UV curing or heat curing. The coating agent may include, for example, any of acrylic, epoxy, polyurethane, polyimide, unsaturated ester, phenol, urea, and melamine resins, and materials containing one or more of these may also be used. For example, the deformation preventing portion 700 formed by spraying may be formed to have a same shape and arrangement as those of the deformation preventing portion formed by the tape attachment as shown in FIGS. 3 to 6. Therefore, the description of the shape, arrangement, size, etc. of the deformation preventing portion 700 formed by the above-described tape attachment may also be applied to the deformation preventing portion 700 formed by the spraying method.

FIGS. 7 to 10 show deformation preventing portions 800 to 800c according to other embodiments of the present disclosure. The deformation preventing portions 800 to 800c shown in FIGS. 7 to 10 may be formed by attaching a tape-shaped curing material in a spot shape or by applying or spraying a curing material to form a spot shape. A curing material tape, or a curing material applied or sprayed is indicated by circles in FIGS. 7 to 10. As the curing material, any of acrylic, epoxy, polyurethane, polyimide, unsaturated ester, phenol, urea, and melamine resins may be used, and materials containing one or more of these may also be used.

FIGS. 7 to 10 show examples of deformation preventing portions 800 to 800c including a plurality of spots 810 to 810c, and the spots 810 to 810c respectively forming the deformation preventing portions 800 to 800c, having a circular shape, but the shapes of the respective spots 810 to 810c are not limited thereto and may be varied in various shapes, for example, a square shape.

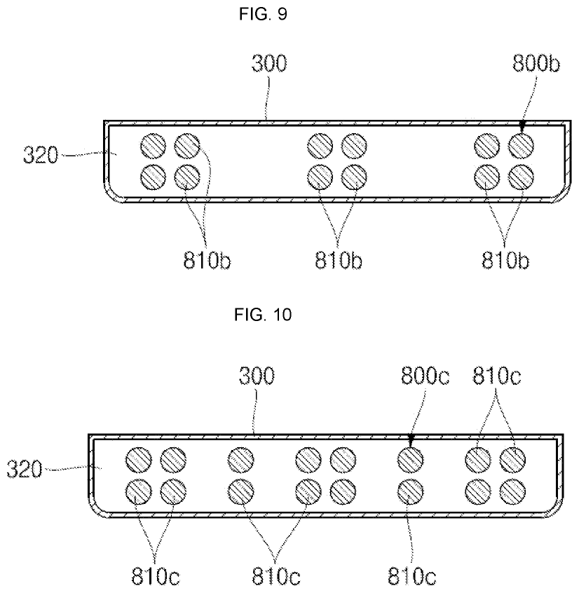

Referring to FIG. 7, the plurality of spots 810 forming the deformation preventing portion 800 may be arranged at equal intervals. By contrast, as shown in FIGS. 8 and 9, the plurality of spots 810a and 810b forming the deformation preventing portions 800a and 800b may be arranged in a plurality of groups, and the respective groups may be spaced at equal intervals.

Further, referring to FIG. 10, the plurality of spots 810c forming the deformation preventing portion 800c may be arranged more densely at edge and center regions and less densely at remaining regions. As a result, the deformation preventing portion 800c is more densely arranged at the edge and center regions of the pouch case 100 where severe deformation may occur. Accordingly, deformation of the pouch case 100 may be prevented or reduced more effectively.

According to embodiments of the present disclosure, by disposing a deformation preventing portion between an electrode assembly and an inner side of a pouch case, it is possible to prevent or substantially prevent (prevent or reduce) the pouch case from being deformed concavely inward due to a decrease in internal pressure due to impregnation of an electrolyte.

While some example embodiments of the secondary battery are provided herein, the present disclosure is not limited to the foregoing embodiments, and it is to be understood by those of ordinary skill in the art that various changes in form and details may be made therein without departing from the spirit and scope of the present disclosure as set forth by the following claims.

What is claimed is:

1. A secondary battery comprising:
an electrode assembly;
a pouch case accommodating the electrode assembly together with an electrolyte; and
a deformation preventing portion at an inner side facing a terminal formation portion of the pouch case.

2. The secondary battery as claimed in claim 1, wherein the deformation preventing portion is formed by any of attachment of a curable tape, application and curing of a coating agent, and spraying and curing of a coating agent.

3. The secondary battery as claimed in claim 2, wherein the coating agent comprises a resin containing one or more of acrylic, epoxy, polyurethane, polyimide, unsaturated ester, phenol, urea, and melamine resins.

4. The secondary battery as claimed in claim 2, wherein the deformation preventing portion has a shape of at least one straight bar.

5. The secondary battery as claimed in claim 2, wherein the deformation preventing portion is arranged as a plurality of deformation preventing portions.

6. The secondary battery as claimed in claim 5, wherein the deformation preventing portion has any of semicircular, circular, and polygonal shapes.

7. The secondary battery as claimed in claim 5, wherein the plurality of deformation preventing portions are arranged at equal intervals.

8. The secondary battery as claimed in claim 5, wherein the plurality of deformation preventing portions are arranged at different intervals.

9. The secondary battery as claimed in claim 5, wherein the plurality of deformation preventing portions are arranged such that an arrangement density thereof at edge and center regions of the inner side of the pouch case is greater than that at remaining regions of the pouch case.

10. The secondary battery as claimed in claim 1, wherein the deformation preventing portion is formed by forming a curing material into a plurality of spots.

11. The secondary battery as claimed in claim 10, wherein the plurality of spots of the curing material are arranged at equal intervals.

12. The secondary battery as claimed in claim 10, wherein the plurality of spots of the curing material are arranged to form a plurality of groups.

13. The secondary battery as claimed in claim 10, wherein the plurality of spots of the curing material are arranged such that an arrangement density thereof at edge and center regions of the inner side of the pouch case is greater than that at remaining regions of the pouch case.
